(19) United States
(12) Patent Application Publication
(10) Pub. No.: US 2026/0127530 A1
(43) Pub. Date: May 7, 2026

(54) SYSTEM AND METHOD FOR INDUSTRIAL LABOR FORECASTING

(71) Applicant: Crewscope Inc., Toronto (CA)

(72) Inventors: Ehsan Foroughi, Toronto (CA); Calvin Benchimol, Toronto (CA)

(21) Appl. No.: 18/936,328

(22) Filed: Nov. 4, 2024

(51) Int. Cl. G06Q 10/0637; G06Q 10/0631; G06Q 10/0639; G06Q 50/04; G06Q 50/08

(52) U.S. Cl. CPC G06Q 10/0637; G06Q 10/063118; G06Q 10/06393; G06Q 50/04; G06Q 50/08

(57) ABSTRACT

A method and system to forecast the labor required for an industrial or construction job based on industry standard job classifications and key job impact factors that affect the labor required to do a job. A new job description is created for a job and matched to an industry standard job classification which has an identification of details pertaining to the industry standard job. A historical job database provides a baseline estimate of the labor required to complete the job based on the new job requirements and the baseline estimate is adjusted to provide a more accurate labor estimate by incorporating the job impact factors that impact the labor required for the job. A work digest for the job can be created and provided to a worker.

### FIELD OF THE INVENTION

The present invention pertains to a system and method of forecasting the labor required for an industrial project based on worker input, job constraints, and machine learning based forecasting incorporating key job impact factors that have a significant effect on labor.

### BACKGROUND

In construction and industrial manufacturing, and other similar sectors of industry, the cost of major projects and industrial production is typically estimated in advance of the project to determine the forecasted budget needed to deliver on the project or meet a production target. In construction projects, the goal or product is typically fixed, as determined by the drawings or job specifications, whereas the labor, or effort cost, is variable. In industrial manufacturing, such as, for example, mining, materials extraction, quarrying, oil and gas, and other extractive manufacturing, labor is typically fixed but output or production is variable, which is reflected in having permanent or fixed workers with fixed salaries and pre-determined shifts. The goal of a plant in industrial manufacturing is generally is to maximize output, and industrial manufacturing companies typically use labor estimates to accurately price their products for market. In a construction project the goal is to minimize labor hours to complete the project. In both cases, being able to accurately forecast the relationship between labor hours and output enables companies to create accurate estimates and fairly price their products and services.

In construction, once the cost is estimated for a construction project, construction companies then bid for the project by leveraging the estimate and adding a desired profit margin as well as risk management paddings. Construction projects are generally awarded to a contractor after the contractor or construction company has prepared a bid for the project and the winning company is bound by the original bid to complete the project. To prepare a bid, the construction company attempts to estimate the cost of the project, including all material, tools, and labor costs, and adds on the desired profit margin, allowing flexibility for overages and contingencies. The estimated cost of any significant construction project needs to be determined accurately in advance of the project. In particular, a bid that is too high could result in failure to win the bid in a competitive bidding process, and a bid that is too low could result in a loss of profit with potentially significant losses.

The cost of large construction projects and industrial manufacturing processes are generally estimated by breaking down the job into smaller components or jobs and estimating each component or job individually, where each component has cost contributions from labor, materials, and equipment. Afterward, the estimate of each of the components is added up, a project administration and management overhead is added, and a risk adjustment value is added to get the cost estimate. A target profit margin is then added to the cost estimate to calculate the bid or market price. The cost estimation of a construction project or industrial manufacturing process must include the labor cost, material cost, and equipment cost for the project, with accurate timing for each stage. Of these factors, material costs are generally straightforward to estimate and are often based on project plans and blueprints, with the amount of materials needed calculable from square footage measurements and materials costs taken from commercial suppliers. Typically, any change from material cost estimations may also be passed onto the project owner or worked into the estimate as external capital costs and have a smaller effect on the profitability of the project. Equipment costs are, in most cases, considered as part of the overhead cost of labor since equipment must be operated by workers and how long the equipment is needed is determined by how many hours will be worked. With knowledge of the labor cost the equipment cost can generally be accurately estimated based on the number days or hours the equipment will be required. In industrial manufacturing, predicting and hitting production output targets given a fixed amount of time and labor, such as amount of material produced per day, provides predictability to costing the resulting product. Labor estimates in industrial manufacturing can depend on various conditions. For example, in open quarries, weather can significantly impact production, with reductions in production of 20% or more on a rainy day compared to a sunny day. Other factors that can impact production numbers in extractive production include equipment availability and environment-related downtime.

Accurate project estimation is, at present, a combination of art and science, and most often falls to skilled human project estimators. Typically, estimate professionals and project managers employed by construction and industrial companies estimate project costs by using their personal experience and understanding of the industry. These skilled professionals are difficult to replace and their practice is often considered to be proprietary and safeguarded. Ultimately, the closer the estimates prepared by these professionals the more revenue is generated by the company and the more profitable the company. Industrial process cost estimation is therefore a critical part of company operations and its profitability and success.

Computer-based methods of project management have been applied to construction projects to track the use of labor throughout the process. In one example, U.S. Pat. No. 11,481,702B1 to Uriarte describes a worksite management information system in which the selection of a task block is received and presented to either a worker, a trade or a builder interface. Once updated, the task is presented to one of the trade interface and the builder interface. In an example of workflow assignment, U.S. Pat. No. 11,625,660B2 to Goli et al. describes a system using machine learning for automatic extraction and workflow assignment of action items from the text of a construction project manual and applying rules to distinguish valid and invalid candidate action items using a first machine learning model. A second machine learning model is then used to allocate each true action item to a construction workflow class.

In the industrial sector, the better and closer the estimate to the ultimately completed project or production goal the more satisfied the client and the more revenue is generated to the company. In construction, an estimation that is too high can miss the bid in a competitive bidding setup such that the company can fail to secure the project. An estimate that is too low can result in jobs that are unprofitable or even end up at a significant financial loss for the firm. Estimate dollar figures for production are generally high in construction and industrial production projects, but profit margins are slim. In one example construction project, a $100M project with a profit margin of 5% leaves $5M profit for the company. Labor cost could be $40M, and $55M material cost. If a mistake is made or there is inefficient execution, and labor cost comes to, for example, 10% more than expected, that 10% in additional labor cost translates to $4M extra cost, bringing the cost of the project up from $95M to $99M, reducing the profit from $5M to $1M, or by 80%. As such, cost estimation accuracy is a critical function for construction firms.

Companies that rely on human labor are also facing an existential problem due to labor shortages. The job market in manual labor is tight and there is a lot of construction and industrial labor work to be done and not enough employees to fill open positions. According to United States Bureau of Labor Statistics (2023) and Statistics Canada (2023), there are more than 500,000 open jobs in construction between US and Canada. Some companies are handing out discretionary bonuses and gifts to poach talent, motivating workers to hop around between companies to maximize financial benefits. Companies that attract, retain, and motivate talent will succeed in this climate, and the rest may struggle to survive. There remains a need for a system and method for accurate forecasting of labor costs for industrial project.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method of forecasting the labor required for an industrial project based on worker input, job constraints, and forecasting based on historical data.

In an aspect there is provided a method for labor forecasting comprising: creating a new job record for a new job, the new job record comprising job specifications and having a classification identifier associated with an industry standard job record; identifying a plurality of historical job records in a historical job database having the same classification identifier as the new job record, each historical job record describing a historical job comprising historical job specifications specific to the historical job; in a labor forecasting engine, receiving the plurality of historical job records pertaining to the job classification identifier and creating a normalized labor forecast based on the plurality of historical job records; identifying one or more job impact factors associated with the industry standard job; and adjusting the normalized labor forecast for the new job record based on the job impact factors to provide an adjusted labor forecast.

In an embodiment, the industry standard job record comprises job requirements for the industry standard job.

In another embodiment, the classification identifier of the new job record is in a category or subcategory of each of the plurality of historical job records used to create the normalized labor forecast.

In another embodiment, the job is an industrial project, construction project, or industrial manufacturing.

In another embodiment the method further comprises querying a worker on details pertaining to the job impact factors.

In another embodiment the method further comprises incorporating the details pertaining to the job impact factors into the adjusted labor forecast.

In another embodiment the method further comprises creating a work digest relevant to the job and communicating the work digest to a worker.

In another embodiment, the work digest comprises one or more of text, an image, audio, and video.

In another embodiment, the work digest provides information on one or more of job conditions, job requirements, job specifications, and job best practices.

In another embodiment, the work digest comprises generated text provided by a Large Language Model, and wherein the generated text reflects sentiments and tone to motivate the worker.

In another embodiment, the work digest comprises specific information about the new job and its progress.

In another embodiment, the job impact factors comprise one or more of weather, time of year, job location, soil or ground type where the job is located, humidity, temperature, surface water level, labor market, materials used, and equipment used.

In another embodiment the method further comprises, once the job is completed, adding the new job record as a new historical job record to the historical job database.

In another embodiment the method further comprises providing a worker with a goal for completing the job within a time allotment for the labor forecast, and rewarding the worker for completion of the job within the time allotment.

In another aspect there is provided a system for labor forecasting comprising: at least one processor coupled to one or more memory, the one or more memory comprising: a job classification database comprising a plurality of industry standard job records, each industry standard job record comprising a job description for an industry standard job and a job classification identifier; a historical job database comprising a plurality of historical job records, each historical job record describing a historical job associated one of the plurality of industry standard job record in the job classification database; a job generation engine for creating a new job record, the new job record comprising new job specifications and associated with one of the plurality of industry standard job records by the job classification identifier; and a labor forecasting engine for receiving the plurality of historical job records pertaining to the job classification identifier, creating a normalized labor forecast for the new job, and identifying one or more job impact factors associated with the job classification identifier, wherein the labor forecasting engine adjusts the normalized labor forecast for the new job based on the identified job impact factors to provide an adjusted labor forecast for the new job.

In an embodiment, the system further comprises a peripheral device for querying a worker about the identified job impact factors and receiving details on the one or more job factors.

In another embodiment, the job impact factors comprise one or more of weather, time of year, job location, soil or ground type where the job is located, humidity, temperature, surface water level, labor market, materials used, and equipment used.

In another embodiment, the industry standard job record comprises job requirements for the industry standard job.

In another embodiment, the job classification identifier is in a category or subcategory of each of the plurality of historical job records used to create the normalized labor forecast.

In another embodiment, the industry standard job is an industrial project, construction project, or industrial manufacturing.

Embodiments of the present invention as recited herein may be combined in any combination or permutation.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 illustrates a labor forecasting system for forecasting labor requirements for an industrial project;

FIG. 2 illustrates the contents of a job classification database in the present labor forecasting system;

FIG. 3 illustrates the contents of a historical job database in the present labor forecasting system;

FIG. 4 illustrates a dynamic job conditions query and update of a labor forecast based on dynamic job conditions;

FIG. 5 illustrates an example of specific job requirements for creating a specific industry standard job record;

FIG. 6 illustrates the preparation of a labor forecast a specific job bid in an industrial project;

FIG. 7 illustrates a machine learning platform for identifying job impact factors and improving labor forecasting using a machine learning model;

FIG. 8 is a flowchart illustrating a method for applying a plurality of forecast adjustment factors to a normalized labor forecast to provide an adjusted labor forecast;

FIG. 9 is a flowchart illustrating a method for forecasting the labor requirement for a new project;

FIG. 10 is a flowchart illustrating a method for deconstructing a new project into a set of industry standard jobs and dynamically updating a project estimate;

FIG. 11 illustrates a graphical user interface of an example work digest on a peripheral device for a job worker;

FIG. 12 illustrates a graphical user interface of a job report for an industrial job for a job manager; and

FIG. 13 illustrates a graphical user interface of a specific job record for an industrial job identifying key job impact factors and job requirements.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprise” and any of its derivatives (e.g. comprises, comprising) as used in this specification is to be taken to be inclusive of features to which it refers, and is not meant to exclude the presence of any additional features unless otherwise stated or implied. The term “comprising” as used herein will also be understood to mean that the list following is non-exhaustive and may or may not include any other additional suitable items, for example one or more further feature(s), component(s) and/or element(s) as appropriate.

As used herein, the terms “comprising”, “having”, “including”, and “containing,” and grammatical variations thereof, are inclusive or open-ended and do not exclude additional, unrecited elements and/or method steps. A composition, device, article, system, use, or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to. The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment”, and “for example” is intended to illustrate or denote aspects, embodiments, variations, elements or features relating to the invention and not intended to limit the scope of the invention.

As used herein, the terms “connect” and “connected” refer to any direct or indirect physical association between elements or features of the present disclosure. Accordingly, these terms may be understood to denote elements or features that are partly or completely contained within one another, attached, coupled, disposed on, joined together, in communication with, operatively associated with, etc., even if there are other elements or features intervening between the elements or features described as being connected.

As used herein, the term “industry standard job” is a job required for an industrial project that can be described in general terms based on the work required and job requirements. A “specific industry standard job” is one which is required in a specific industrial project and is defined by a specific location.

As used herein, the term “job requirements” refers to a set of tasks required to do a particular industry standard job. For a particular industrial job the job requirements will generally consist of a set of standardized tasks. In one example, the job requirements for the particular industry standard job of pouring a concrete pad may include standardized tasks such as, for example, digging out a pad, leveling the ground, preparing and/or setting a concrete form, preparing a base using aggregate, pouring the concrete, surfacing the concrete, and removing the concrete form.

As used herein, the term “job specifications” refers to the conditions describing a specific industrial job at a specific location in a specific project. Job specifications can also include, for example, materials specified for the job, a project plan, job location, ground conditions, safety considerations, and time of year.

The term “job classification identifier” used herein refers to a unique number or identifier associated with an industry standard job in a job classification database.

Herein is described a system and method of forecasting the labor required for an industrial project. A complexity adjusted labor forecast is determined based on industry standard job classifications in a database of industry standard jobs, a historical database of completed jobs, and key job impact factors that affect the labor required to do an industrial job. The historical job database together with a labor forecasting engine provides a baseline estimate or normalized labor forecast based a set of historical job records, which include the specifications and labor required to complete the historical job. A labor forecasting engine receives a set of relevant historical jobs and creates a normalized labor forecast based on the relevant historical jobs compared to the job specifications of the new job, and then adjusts the labor forecast using forecast adjustment factors which are based on key job impact factors which have been identified as having the most impact on the labor required for the job.

The present method and system can provide an accurate labor estimate by incorporating the job impact factors that impact the labor required for a job. The identification and use of key impact factors which most affect the labor required for an industrial job enable the present system and method to use only a limited number of historical job records to create a normalized labor forecast while still arriving at an accurate labor forecast for a new job using forecast adjustment factors. Reducing the uncertainty in labor cost forecasting in pricing an industrial project or job and/or the product of an industrial project or job leads to more efficient, predictable, and profitable pricing for contractors, plant managers, and industrial companies for which human labor affects the cost of goods or services that they produce. Additionally, the use of dynamic labor estimate updating based on dynamic job conditions allows project managers to have visibility on labor spend during the course of an industrial project.

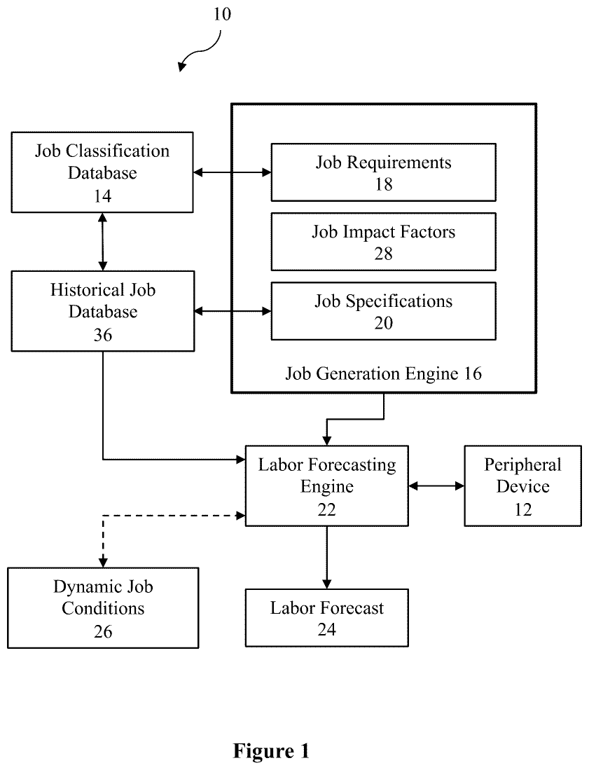

FIG. 1 illustrates a labor forecasting system 10 for forecasting labor requirements for an industrial project. The forecasting platform described herein can be specifically applied to the estimation of labor costs in construction and industrial project management to estimate the various job impact factors affecting the labor required for doing an industrial job to gain an accurate labor forecast for an industrial project. The present system and method of forecasting the labor required for an industrial project is based on matching an industry standard job classification to a new job, and providing a labor estimate for the new job based on the key impact factors that affect labor. Together with input from workers and/or dynamic job conditions 26, a labor forecasting engine applying machine learning can arrive at a complexity adjusted labor forecast for the job. A new job description is created for a job and matched to an industry standard job classification which has an identification of details pertaining to the industry standard job. A historical job database 36 provides data required by the labor forecasting engine 22 to provide a normalized or baseline labor forecast of the labor required to complete the job based on the new job requirements. The normalized labor forecast is adjusted using forecast adjustment factor based on the dynamic job conditions and additional input during the job to provide a more accurate labor forecast by adjusting the normalized forecast using the job impact factors 28 that impact the labor required for the job.

The job classification database 14 comprises a set of industry standard jobs classified by type, with each industry standard job having a unique classification number. An industry standard job can be described in an industry standard job record that describes the work required and job requirements for completing a job. Industry standard jobs can be grouped into general categories. In some examples, subsets of industry standard jobs in the job classification database 14 for the construction industry can include plumbing, electrical, tiling, masonry, painting, concrete pouring, drywall installation, paving, forming, and earthworks. Other industry types can have other subsets of industry standard jobs that are specific to their industry. Job types for each industry standard job typically form a canonical style of representation where major category types, minor category types, and sub-types might be used with up to a few levels of specificity and detail. In one example, the major category type of industry standard job “Earthworks” may be further delineated into category subtype “Excavation”, with further subtype “Fine Excavation—Machine-assisted fine excavation”.

The historical job database 36 comprises a set of historical job records that have been previously done, completed, and recorded. Each historical job record in the historical job database 36 comprises a classification identifier linking it with an industry standard job in the job classification database 14 along with specific job conditions and job specifications for the historical job that was done. Details in each historical job record can include, for example, the worksite location of the job, the date and time the work was done, how many people were required to do the job, the level of skill of the workers who did the job, what materials (i.e. consumables) were used to do the job, what challenges the workers experienced on the job, what equipment was used for the job (e.g. a large excavator vs. a small one can take different amount of labor hours in operation to dig the same volume), and any other job-specific conditions during the job. Job-specific dynamic job conditions 26 may include, for example, environmental conditions such as weather, temperature, humidity, precipitation.

In estimating a new job, a new job record is created for the new job with a job generation engine 16 such that the new job record can be compared to historical job records in the historical job database to provide a labor estimate for the new job. Both the new job record and historical job records can then be provided to a labor forecasting engine 22 to create a labor forecast for the new job based on historical information from historical job records with the same job classification identifier. The new job record is assigned a classification identifier from the job classification database 14 to identify it with a specific industry standard job. The job generation engine 16 creates a new job record comprising the set of job requirements 18 taken from the industry standard job record of the same classification identifier in the job classification database 14, as well as job specifications 20 as dictated by the project. Job requirements 18 are a set of tasks or activities required to do a particular industry standard job, and job specifications 20 are the specific conditions, materials, equipment, and details describing a specific job for a specific project. The job specifications 20 can include, for example, materials required for the job, project plans, size or measurements of the job, job location, and time of year.

To create a labor forecast for the new job record with job generation engine 16, the job requirements 18 and job specifications 20 along with the classification identifier for the new job are input into the labor forecasting engine 22, along with historical job data from specific industry standard job records having the same classification identifier. The labor forecasting engine 22 compares the data pertaining to the new job record and data from the specific industry standard job records having the same classification identifier in the historical job database 36 and prepares a labor forecast 24 based on projections and actual data from previously completed historical jobs. Identification of key job impact factors 28 for any industry standard job provides one or more adjustment factor which can be input into the labor forecasting engine 22 to improve the accuracy of the labor forecast 24.

Job impact factors 28 pertain to aspects of an industry standard job that are variable for specific jobs and have a significant effect on the labor required to do a specific job. Job impact factors 28 enable the modification of the labor forecast based on the specific kay factors relating to the industry standard job described in the industry standard job record that have the most impact on labor. Job impact factors in industrial jobs can include, for example, weather, temperature, worker experience, materials, equipment limitations, etc. that are identified as affecting the efficiency or time duration of the work, and therefore the labor required to complete the work. In one specific example, for excavation under the earthworks category in the job classification database 14, job impact factors 28 include: how much fine excavation is required, such as in areas that have other underground structures such as tunnels and subways close by, versus bulk excavation; presence of groundwater (if there is significant ground water present, water needs to be regularly pumped out, and shoring might be needed); weather and season, as freezing weather makes the ground harder to excavate, and rain can cause water challenges; soil type; rock size; and ground hardness.

Job impact factors 28 can be either identified as relevant to a particular industry standard job, or can be identified as additional job impact factors by a worker working on a specific job at the job site. In an example of setting paving tile, the job requirements 18 in a new job record may provide a labor forecast based on adequate time for the laying of 1-inch thick paver units, which weigh about 11 pounds per square foot, but the material provided in the job specifications 20 may be 2-inch paver units which weigh about twice the expected amount. The equipment and/or labor assigned may not have taken into consideration the larger pavers and there may be insufficient labor and/or equipment to complete the work in the expected time as forecasted based on the historical job database 36. By specifying the type and size of material as part of the job impact factors 28 the additional time required for setting the larger pavers can be adjusted in the job record to update the overall labor forecast 24. On the work site, updates to the job specifications 20 and job impact factors 28 can optionally be done by a worker or manager from a peripheral device 20 using a graphical user interface. Before and during the course of the job, dynamic job conditions 26 can also be used to adjust the labor forecast 24 in the labor forecasting engine 22. In particular, a labor forecast 24 based on average weather or temperature conditions for a particular location at a particular time of year can be adjusted when weather and temperature conditions during the actual job deviate significantly from average, providing an adjusted labor forecast based on the dynamic job conditions 26. Dynamic job conditions 26 can also be updated by querying workers or foremen on different aspects of the job that are impacting the labor time required in real time. This can be done in dynamic job conditions query on an electronic device or peripheral device 20 that workers use, for example a smartphone or tablet.

In large construction projects, for example, office buildings, multi-unit residential buildings, and large complexes, there are many jobs that need to be done to complete the project. Each job must be done in a particular order or schedule, and each job has a set of requirements or sub-tasks that need to be done to complete the job. Each component of labor estimation is typically a small aspect or job in the larger project that needs to be performed. In the estimation of a construction project, labor cost forecasting has the most variability in a construction project and are the most difficult to estimate. There is a great deal of variability in labor required, with more experienced workers generally taking a shorter amount of time to do a job than less experienced workers. The complexity of the job can also make it more difficult to forecast the amount of time needed for its completion. Other factors can also contribute to labor forecasting for industrial projects, such as, for example, local labor rates, distance from materials and equipment suppliers to the industrial site, fuel costs, supply chain challenges in material and equipment availability, and labor availability. These factors are difficult to take into account when forecasting project and labor requirements. For complex construction project management, the present system and method can be used to project an overall labor forecast for a single project having thousands of new job descriptions each with its own job specifications 20 and job requirements 18. With the present system and method a labor forecast 24 can be easily provided for the entire construction project based on an forecast of labor required to do each individual job.

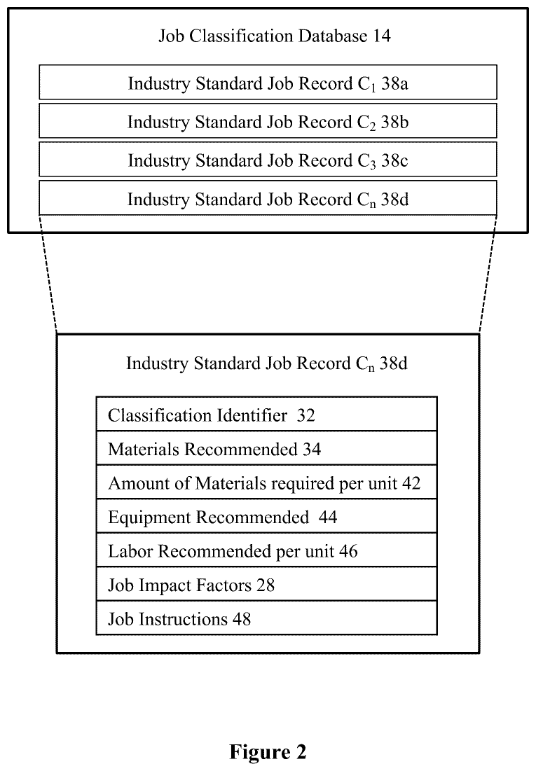

FIG. 2 illustrates the contents of a job classification database 14 in a labor forecasting system. The job classification database 14 comprises a plurality of industry standard job records 38a, 38b, 38c, 38d, with each industry standard job record having a classification identifier C₁, C₂, C₃ . . . Cₙ. There can be many thousands of industry standard job records in the job classification database 14, each with a unique classification identifier. Industry standard job records 38a, 38b, 38c, 38d can be based on existing or new lists, and can be added to the job classification database 14 to improve granularity of data collection for each industry standard job record. In an example of a breakdown of construction industry standard jobs, the Construction Specifications Institute provides a MasterFormat™, which is a lengthy listing of classifications for industry standard construction jobs by type. In one example, a list of industry standard jobs for construction activities can include a general classification for the maintenance of cast concrete. This general classification can be further divided up into a plurality of industry standard jobs pertaining to the maintenance of cast concrete, each with its own unique classification identifier. These can include, for example: maintenance of concrete forming and accessories; maintenance of concrete reinforcing; maintenance of stressing tendons; maintenance of cast-in-place concrete; cleaning of cast-in-place concrete; resurfacing of cast-in-place concrete; rehabilitation of cast-in-place concrete; strengthening of cast-in-place concrete; maintenance of precast concrete; cleaning of precast concrete; resurfacing of precast concrete; rehabilitation of precast concrete; strengthening of precast concrete; maintenance of cast decks and underlayment; cleaning cast decks and underlayment; resurfacing of cast decks and underlayment; rehabilitation of cast decks and underlayment; strengthening of cast decks and underlayment; maintenance of concrete grouting; maintenance of mass concrete; maintenance of concrete cutting and boring; maintenance of structural cast-in-place concrete; maintenance of concrete forming; maintenance of concrete slip forming; maintenance of concrete shoring; maintenance of concrete falsework; maintenance of architectural cast-in-place concrete forming; maintenance of concrete form liners; insulating concrete forming; and maintenance of concrete permanent stair forming.

Starting with a set of industry standard jobs each with a unique classification identifier, each industry standard job record Cₙ 38d can comprise data pertaining to the industry standard job. These can include, for example, a job classification identifier 32, materials recommended 34, amount of materials required per unit 42, equipment recommended 44, labor time recommended per unit 46, skills recommended for workers, etc. In the case of concrete casting, the recipe, composition, type, or formula of the concrete used in a specific job will have an effect on the amount of labor time required, equipment needed, and preparation and finishing labor needed to complete the job. In one example of cast-in-place concrete, various cast-in-place construction material concrete types that may be used include but are not limited to: structural concrete; architectural concrete; low-density concrete; post-tensioned concrete; heavyweight structural concrete; lightweight structural concrete; shrinkage-compensating structural concrete; high-performance structural concrete; self-compacting concrete; decorative non-structural concrete; heavyweight architectural concrete; and lightweight architectural concrete. The job classification database may have a general category for setting “cast-in-place concrete” and subcategories for each type of concrete used. The concrete for any specific industry standard job may also contain one or more admixes, additives, aggregates, cements, coloring agents, fly ash, accelerators, bonding agents, air entrainment additives, curing agents, densifiers, hardeners, plasticizers, retarders, and sealers. Various construction resources and equipment can be relevant to the time required for casting and maintenance of cast concrete, including, for example: permanent and temporary forms for structural and architectural cast-in-place concrete such as metal pan forms, wood forms, plastic forms, slip forms, and corrugated paper forms; anchors such as cast-in anchors, inserts, expansion and contraction joints, and waterstops; structural reinforcement for concrete forms such as tension, compression, and temperature-reinforcing steel for concrete, coated reinforcing steel, and reinforcing steel; and forming accessories such as form liners, void forms, manufactured joints, form anchors, and form inserts. The use of these different types of equipment can change the complexity and time required to perform a particular industry standard job, and identification of the equipment required for a particular job specification, along with the type of material required, will provide a determination on the time required to complete the specific industry standard job.

In another example, the number of labor hours to apply paint may vary significantly based on the location of the paint job (floor, wall, ceiling, indoor, outdoor, height of application, etc.) type of paint used, equipment used, as well as external weather conditions. In a specific outdoor example, the type of paint in combination with the equipment used and local weather conditions can affect the ease or challenge of the coating application. Various types of paint behave very differently under different conditions, and can include, for example: interior/exterior architectural paints, deck coatings, floor paints, elastomeric, primers, sealers, under-coaters, stains, shellacs, lacquers, varnishes, urethanes, waterproofing concrete, roof, wood sealers and repellents. The use of other specific additives, such as thinners, spirits, solvents, and other additives, can change the thickness, hardening time, and optimal temperature range for the paint. The job classification database 14 can include a listing subcategory of industry standard job records for applying different kinds of paint using different kinds of paint applications methods to different kinds of surfaces. Surfaces may include different materials, or different structural types such as walls, floors, ceilings, stairs, greater than standard-height rooms, etc. Identifying job impact factors 28 which most affect the time required to complete the job provide an opportunity for a manager to identify the most relevant job specifications relating to the job impact factors 28 such that a more accurate labor forecast can be obtained for the job. The industry standard job record may also include job instructions 48 or guidance for completing the job, which can optionally be provided to a worker in a work digest to give them information on how to complete the job.

In addition to adjusting a labor forecast for an industrial job based on job impact factors, understanding the actual labor time required for each industry standard job based on the environmental, equipment, and material conditions surrounding and required by the job can enable identification of both optimal and less than optimal conditions that lengthen or shorten the labor required to do the job. This can further provide an accurate forecast of jobs of different sizes based on specific working conditions and requirements, and can also be used to identify improvements to work practices that make construction work more efficient. In the example of a concrete pour, humidity and temperature can both affect the amount of setting time required, as well as can change the recommended concrete mixture for pouring. In the job instructions 48 for an industry standard job record, recommendations and instructions can be provided to workers on how to do the industry standard job required, and what the worker should potentially change or be aware of in view of the job specifications for the specific industry standard job they are doing. Once any a new job has been completed, a job record for the completed job, along with all of the collected data in the job record pertaining to the details of the specific job can be stored in a historical job database. In this way data collected for each completed job can be used to provide data to the labor forecasting engine to forecast the labor required for future jobs so that future jobs can be more accurately estimated.

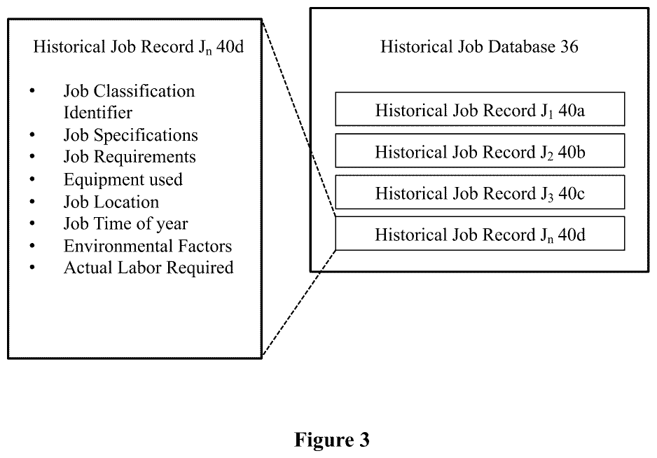

FIG. 3 illustrates the contents of a historical job database 36 in a labor forecasting system. The historical job database 36 comprises a plurality of historical job records 40a, 40b, 40c, 40d, each with a specific job identifier J₁, J₂, J₃, Jₙ. Each historical job record 40a, 40b, 40c, 40d is a record of a specific job done for a specific job on a specific project. Once a job is complete, the job record can be added to the historical job database 36 as a historical job record. Each historical job record has a classification identifier linking it to an industry standard job classification in the job classification database. Additionally, each historical job record has a record of the specific details relating to the specific job, which can include, for example, specific job specifications, altered job requirements different from the industry standard job requirements, job materials used, amount of job materials used per unit, job equipment used, labor required per unit, job time of year, job location, project type, environmental factors, job and actual labor required to do the job. In construction, the goal is typically fixed, as determined by the drawings or job specifications, whereas the labor, or effort cost, is variable. In industrial manufacturing, on the other hand, labor is typically fixed, and output is variable. This is reflected in having permanent/fixed workers with pre-determined shifts. The goal of the plant generally is to maximize output rather than minimize labor hours. The present labor forecasting method and system applies a smart forecast adjustment to the labor hours estimated using the historical job records, and all the methods and processes specified herein can be apply to many different industrial processes and jobs, including construction, industrial production, materials and minerals extraction, and industrial manufacturing.

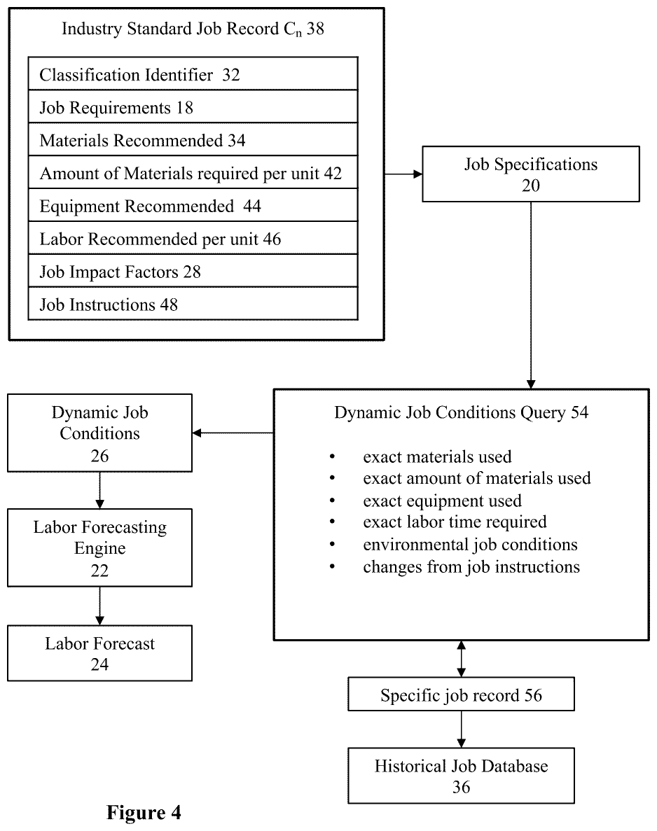

FIG. 4 illustrates a dynamic job conditions query and update of a labor forecast 24 based on dynamic job conditions 26. For a new job, a specific job record 56 can be created for a an industry standard job for a specific job. Job specifications 20 are put into the specific job record 56 and the specific job record 56 is matched with an industry standard job record 38 having a classification number Cₙ. The industry standard job record 38 can comprise, for example, a job classification identifier 32, job requirements 18, materials recommended 34, amount of materials required per unit 42, equipment recommended 44, labor recommended 46, job impact factors 28, and job instructions 48. The specific job record 56 comprising the job specifications for the new job can then be presented to a worker before, during, and/or after the job in a dynamic job conditions query 54 to add detail to the specific job record 56 to provide additional granularity around the job conditions. These job conditions can include, for example, exact material used (i.e. manufacturers identification, lot number, etc.) exact amount of materials used, exact equipment used, exact labor time required, environmental job conditions, and changes from job instructions provided in the industry standard job record. The dynamic job conditions query 54 can be presented to a worker on a peripheral device in a graphical user interface, and may also optionally be obtained from external sources such as weather and environmental data at the industrial work site. Dynamic job conditions 26 can be determined and supplied to the labor forecasting engine 22 to provide an updated labor forecast 24 based on the dynamic job conditions.

Based on the dynamic job conditions 26, workers can also be incentivized to change the way they work to achieve productivity gains, so long as the job specifications 20 for the job are met. It has been established in psychological research (e.g. theory of goal setting) that suitable goals need to be “challenging yet attainable” to be motivating. The “S.M.A.R.T.” method of goal setting provides that well-set goals are Specific, Measurable, Achievable, Relevant, and Time-Bound. The “achievable” nature of a goal relates to the present system because a good forecast will make a good and reasonable goal that is achievable. Further, based on the dynamic job conditions 26 and the industry standard job record 38d, workers can be provided with a digest of job instructions to assist the worker and crew with performing the job efficiently and according to the job specifications. The digest can be provided on, for example, a smartphone or tablet, or any peripheral electronic device frequently used by the workers, managers, and crew.

The initial labor forecast 24 for the specific job record 56 can be done using an average crew, or typical crew, which is generally comprised of one foreman with experience and a mixed group of variably experienced people. A more experienced crew member may cost more but take less time, so unit productivity can be considered a wash. However, in the case where the job impact factors suggest that a worker having a particular skill makes a significant difference to the labor forecast 24, this can be taken into account by the labor forecasting engine 22 based on the crew doing the job.

In one example of combining an industry standard job record 38 with specific job specifications 20 and data gleaned from a dynamic job conditions query 54, the technical details surrounding a particular job can be extracted and modeled. In one example, the present system can model any industry standard job by taking into account the following dynamic job conditions that may have significant impact on the labor forecast, independently or put together:
Units of work, e.g. 200 square meters of asphalt, or 100 cubic feet of concrete pour
Labor hours involved: Total labor required by a crew to get the specified amount of work done, e.g. 1500 labor hours
Unit productivity or labor hours required per unit of activity (labor hours divided by units). Climate factors, such that those that could affect the surrounding environment, for example weather, temperature, humidity, wind, pressure, rain or precipitation, season (e.g. summer, winter)
Ground and water conditions such as ground hardness, groundwater, and other water conditions
Environmental factors such as presence of wildlife, soil or ground contamination
Structural factors such as building or surface exposure (e.g. north, south, east, west . . . ), if a renovation, age of building (where older generally means less modern techniques requiring more effort), and size of building

Some of these dynamic job conditions are relevant to certain types of activities while others might not be relevant. For example, installing bathroom tiles is typically done indoors and not dependent on the weather conditions. As a part of tracking worker and crew task and productivity, the dynamic job conditions query 54 can collect more granular data on the task that the crew is doing. To do this, the dynamic job conditions query 54 can ask the crew various questions related to the particular job where the questions pertain to key job impact factors that affect the labor required to do the job. This data can then be used to obtain more granular information on the relationship between the work time required to do a job and specific job-related details. Some specific examples of job-specific factor data collection include: specific materials used (i.e. for a grouting task, what type of grout? for a tiling task, what type of tile?); specific tools used (i.e. specific hand tools, specific power tools, specific large machinery, etc.); and soil conditions (i.e. what is the soil type at the site? how packed is the soil? how wet is the soil?) A query to a large language model can also be used to identify job impact factors that may affect the labor required for the job. Other data can be collected either using local data, or from the worker(s) or crew, that affects productivity at the job site. In one example, rain followed by a freeze event can make the ground both heavy and hard, which affects excavation productivity. High wind conditions can make it more difficult and dangerous for certain construction tasks, including outdoor tasks that involve cranes and fine dexterity. Some of these factors include: local weather (i.e. is it raining or snowing? how much rain? what is the wind speed? how much rain or snow has there been in the last days/weeks?); local temperature; and local temperature fluctuation (i.e. has there been precipitation followed by a freeze?).

In the dynamic job conditions query 54, workers can be asked to select from a drop down menu to provide additional details on these job-specific impact factors, or be provided with other input means to answer questions. The data obtained from the on-site crew can help the management understand why a job may have taken more or less time, and also provide insight on how such factors affect work productivity for use in future project bidding and pricing. To do this, once the specific job is completed the specific industry standard for the specific job completed is added to the historical job database 36 as a historical job record to be used in future modeling.

Engaging workers in providing pertinent data and in decision making empowers them to use their knowledge to improve their work and meanwhile report back what they did and why they did it. In a crew with mixed experience and a goal to get the job done in a given amount of time, the foreman will typically organize the crew to ensure maximal productivity, which means giving lower skill work to people with less experience and high skill work to more experienced crew members. Empowering the foreman to organize the crew and reward all crew members for the achievements of the crew together changes the power dynamic on the site, encouraging all members to pull for the same team so that everyone can be rewarded.

One specific real world example is provided to illustrate the power of collecting dynamic job conditions for a specific in-progress job to improve best practices on a construction site, achieve efficiencies, and improve labor forecast. A storm water main was being installed in a municipality in Ontario, Canada. The crew was installing units of water pipes. Prior to implementing the present system the workers were solely getting paid by the hour and timelines and productivity were not a factor in their earnings. The present system provides an opportunity for workers to earn more if they do the job better. For the work of laying water pipes the construction company was paid by the municipality per unit of pipe piece installed. The work involved the industry standard work of digging a trench, leveling the trench bed, putting aggregate in the trench bed to support the pipe, laying the pipe, and covering the trench after the pipe has been installed. In accordance with the industry standard, because of the presence of ground water, to prepare the trench bed the crew had to pump water out of the excavation site before preparing the trench for laying pipe. Before using the present system the crew would arrive at the job site in the morning, start the sump pumps to clear the water from the trench, then begin working a couple of hours later after the water had been cleared. After using the present system workers were incentivized to work smarter. The crew realized that if they set up the sump pumps the night before work began and turned the pumps on a few hours before the start of the work day then the trench would be cleared of water by the time the crew arrived at work. This saved hours of time and improved job productivity without changing the amount of labor required for the job. Having granular information on the dynamic job conditions of a specific job and how a particular work job was ultimately done enabled the construction crew to select a more expedient method that gets the best results based on collected labor as well as work condition data. It also enabled the reporting of the labor time gain to management which encouraged operations change. As a result, the crew was given a bonus for their smart work and the company benefitted by faster completion time.

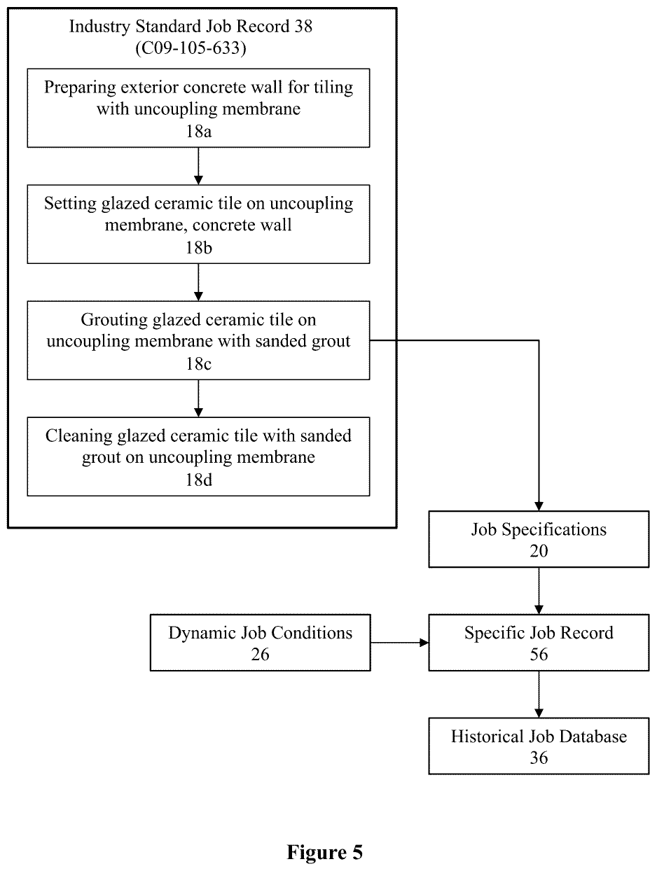

FIG. 5 illustrates an example of specific job requirements for an industry standard job for creating a specific job record 56. In the example shown the industry standard job record 38 for the industry standard job has a plurality of job requirements 18a, 18b, 18c, 18d. A new job description can be created as a specific job record 56 in a job generation engine using job specifications 20 for the specific job. In addition, a classification identifier associated with the specific job record 56 matches the specific job to an industry standard job record 38 that pertains to the specific job. Once the new specific job record 56 is matched to an industry standard job record, the job requirements 18 of the industry standard job can be imported into the specific job record 56. The set of job requirements 18a, 18b, 18c, 18d has an identification of details pertaining to the tasks required to complete the specific job. In this case the job is the tiling of an exterior concrete wall, and the job requirements 18a, 18b, 18c, 18d for the job can be extracted from the industry standard job record 38 from the job classification database.

Each industry standard job record 38 can identified with a classification identifier, for example C09-105-633, and the industry standard job record 38 defines the general type of work, general work location (i.e. interior/exterior, wall/floor, etc.) and materials used for the work (i.e. type of tile, type of grout, etc.). The job requirements 18 for this industry standard job record 38 are: preparing exterior concrete wall for tiling with uncoupling membrane 18a; setting glazed ceramic tile on uncoupling membrane, concrete wall 18b; grouting glazed ceramic tile on uncoupling membrane with sanded grout 18c; and cleaning glazed ceramic tile with sanded grout on uncoupling membrane 18d. In this example, industry standard job C09-105-633 38 as applied to a specific construction project with job specifications 20 will create a unique specific job record 56 which stores the details around the execution of the industry standard job C09-105-633 38 as performed at the specific site as part of a specific construction project. Additional detail for each specific job record can be provided by the construction company, contractor, workers, foremen, architect, or by external data collection as dynamic job conditions 26 as and added to the relevant specific job record 56. Once the job is complete the specific industry standard job record 56 is added to the historical job database 36. The specific job record 56 can also be stored in the historical job database 36 with other specific job records such that it can be searched by its classification identifier for use in future labor forecasting for future jobs.

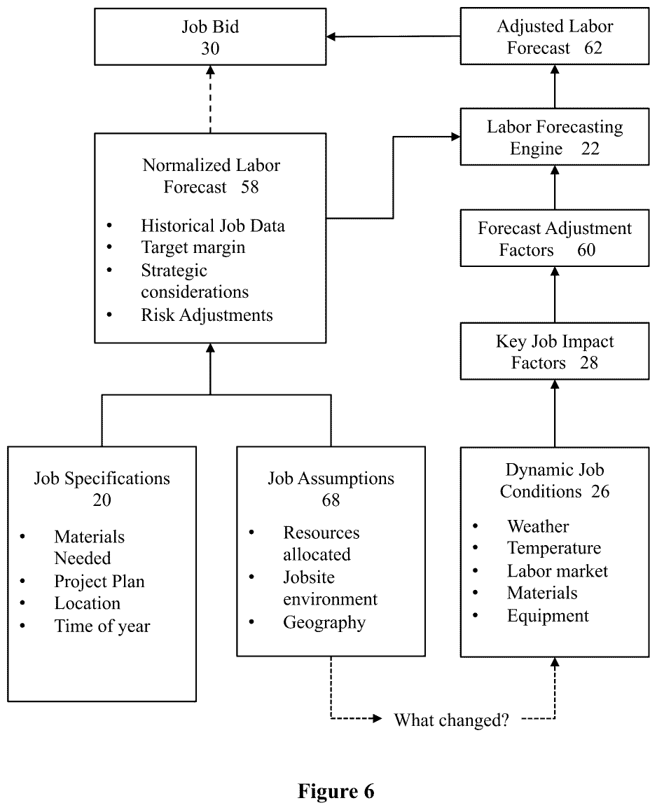

FIG. 6 illustrates the preparation of a labor forecast a job bid 30 for a specific industrial job. In any given specific job there will be job specifications 20 such as materials needed, project plan, location, and time of year for the specific job. Certain assumptions can also be made regarding resource allocation, jobsite environment, and geography, based on the location and time of year and other job specifications. The job specifications 20 and job assumptions 68 can then be provided to a labor forecast engine together with historical job records similar to the job being done to provide a normalized labor forecast based on historical work and specific job specification and assumptions. The normalized labor forecast 58 can be prepared also having regard to target margin, risk adjustments, and other strategic considerations. Without further consideration, this normalized labor forecast 58 can be used to create a labor forecast for a job bid 30. However, it has been found that certain key job impact factors 28 can have an outsized effect on the labor forecast, and that creating forecast adjustment factors 60 based on the identified key impact factors 28 can provide a more accurate and complexity adjusted labor forecast which comes closer to the actual labor effort required for the job. In particular, a small set of dynamic job conditions 26, which might not be fully accounted for in the job assumptions 68 may have a significant an outsized effect on the labor required. These are identified as the key job impact factors 28. Dynamic job conditions which can significantly affect the labor required include but are not limited to weather, temperature, labor market, materials used, and equipment used. Worker input about the dynamic job conditions can be collected while the work is being done to update the labor forecast dynamically in real time while the job is being done. This worker provided data is entered into the labor forecasting engine 22 which generates a labor estimate based not only on information from the historical job database, but also using forecast adjustment factors 60 which have been identified has having a significant effect on the labor required. The complexity adjusted labor forecast 62 can then used to generate an accurate construction project bid 30. In addition, with the use of forecast adjustment factors 60 which are specific to each industry standard job, the number of historical job records needed to arrive at a reasonable labor forecast is reduced and replaced with data around known key job impact factors 28 which have an outsized influence on the labor required.

No two industrial jobs or projects are the exactly same. In particular in outdoor and large scale projects there can be significant deviation in labor requirements based on dynamic job conditions which can have an unexpected and significant effect on job and project costs. By identifying key impact factors 28 and determining forecast adjustment factors 60 that have the most impact on labor required for a job, the present method and system can significantly reduce the number of historical job records needed to arrive at a reasonable labor estimate for a new job.

In one specific example, tile installation jobs are sized by the square feet of tiled surface. So productivity translates to square feet of tiles installed per labor hour of a skilled tile installer. Tile installation jobs depend on the type of tiles being installed. For industry standard jobs in the general classification of tiling, MasterFormat™ defines the following tiling job sub-types based on tile type:
09 30 13 Ceramic Tiling
09 30 16 Quarry Tiling
09 30 19 Paver Tiling
09 30 23 Glass Mosaic Tiling
09 30 26 Plastic Tiling
09 30 29 Metal Tiling
09 30 33 Stone Tiling
09 30 36 Concrete Tiling
09 30 39 Brick Tiling

For the sake of this particular example, a comparison can be made between industry standard job requirements for ceramic tiles (including porcelain) to glass mosaic tiles. Small glass mosaic tiles typically require more effort for installation than large ceramic tiles, as they need more alignment effort on setting and more grouting effort on sealing. Larger ceramic tiles are faster to install, in particular in a larger space, as they require fewer alignment steps and have overall fewer grout lines per tiled area. On the other hand, tiles can be installed on the floor, on the walls, and on some occasions such as showers or pools, on the ceiling. Installing tiles on the ceiling is a much more complex and time-consuming job compared to tiling floor, with tiling of walls somewhere in between the time required and difficulty of a ceiling compared to a floor. So for tiling, in addition to the type of tile, as identified by the job questions to ask is where they are put in, between floor, walls, or ceiling, type of tiles, and finally size of tiles. In this example there are nine types of tiles (ceramic, quarry, paver, glass mosaic, plastic, metal, stone, concrete, and brick), three types of locations (floor, wall, ceiling), and three types of sizes (small, medium, and large). That translates to 81 combinations of jobs. If each combination requires at least 10 data points, meaning at least 10 historical job records pertaining to the same industry standard job, this means that at least 810 historical job records are required before the system can reasonably estimate tiling jobs. In this example, using key job impact factors, an adjusted labor forecast 62 can be created with 30 historical job records to compare size factor (3×10), 30 to historical job records to compare location complexity, and 90 historical job records to compare tile types, bringing the total number of records needed to 150, or 5.4 times less historical data required.

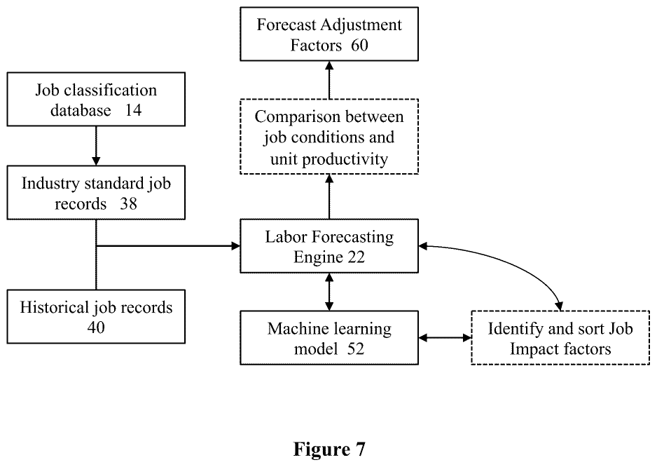

FIG. 7 illustrates a machine learning platform for identifying and sorting job impact factors and improving labor forecasting using a machine learning model. Due to a large number of variables and job specifications in an industrial project, it is usually not possible to find exactly the same or even largely similar conditions for a job from within the historical job records in a historical dataset. However a machine learning model 52 can be trained to use limited historical data to intelligently infer a reasonable labor forecast based on existing similar data using impact factors identified as highly significant to labor required. The machine learning model 52 uses actual historical job records 40 from a historical job database on prior labor activities performed to predict, in a labor forecasting engine 22, the future labor cost of similar new jobs based on the similarity of the new job description to historical job records. A comparison of job conditions and unit productivity can further identify forecast adjustment factors 60 which are dynamic job conditions that have an outsized effect on labor requirements. The present system and method provides an objective forecasting of labor required in an industrial project using machine learning and data modelling. Details on specific industry standard jobs undertaken by workers can provide additional and dynamic feedback on job impact factors that affect productivity which can further enable the updating of labor forecasting as well as knowledge on potential job efficiencies that can be gained during construction work. Industry standard job records 38 stored in a job classification database 14 and matched to a new job record by classification number can extract similar data as a basis for the labor forecast.

The first step in building the machine learning model 52 is to identify the correlation of various job impact factors for each type of job with the unit productivity of the industry standard job. The types of impact factors for a particular job can include, for example, environmental factors, worker skill factors, weather factors, materials factors, and other factors, also referred to as dynamic job conditions, that can vary from job to job for a specific industry standard job. This requires a statistically reasonable number of data points for each job type. In one embodiment, the labor forecasting engine 22 models a correlation of each job impact factor with each activity to determine a correlation factor, which is an indication of the effect of the impact factor on the industry standard job. In this case is the ‘effect’ of the job impact factor is assumed to be predominantly on labor hours. The correlation factors for each industry standard job type and each job impact factor can then sorted by highest correlation to lowest correlation and the job impact factors with highest correlation can be weighted to provide forecast adjustment factors for each industry standard job.

A model correlation factor table, i.e. CR_t_f, where t is the activity type index, and f is the factor index, and CR is a correlation factor between 0 and 1, where 0 suggests no correlation, and 1 suggests linear correlation. In this way a ranking of relevant job impact factors, with job impact factor set and job impact factor ranking specific to each industry standard job (classification) can be created. Most of the job impact factors will be close to 0, except for a few factors which are referred to herein as key job impact factors, and which have a significant effect on labor forecast. With identification of the top few key job impact factors the present method and system can arrive at 95% about accuracy for labor forecasting.

In one embodiment, based on historical data, for a given job type t, CR_t_1 to CR_t_N are calculated and sorted so that CR_t_s1>CR_t_s2>CR_t_s3 . . . >CR_t_sN where s1 to SN are ordinal numbers of the sort. [s1, s2, . . . , sM] where M is a reasonably low number (e.g. 6) forms the factor array of the job type t. Research suggests that many complex decisions in the brain come down to a few factors of decision, somewhat similar to the 80-20 rule, where 80% of the accuracy comes down to 20% of the input data. Additionally, a few large factors can overwhelm a lot of loosely correlated data. By understanding which job impact factors have the most impact for a work job, the prediction of labor time required can be simplified and based on limited information on these key job impact factors and a few key inputs.

Based on historical unit productivity data, a machine learning model can then calculate the impact volume for each job impact factor (e.g. groundwater will typically lower the unit productivity by 20%). Job impact factors can also be normalized to a limited number of levels (e.g. Ground water none, low, medium, high). When an industry standard job type t needs to be estimated, the model then attempts to collect the job impact factors that were identified as relevant for the particular industry standard job. Certain job impact factors such as weather forecasts can be collected using job data such as location and existing historical data for that factor (e.g. weather and groundwater based on location, or skills level based on the skill level of crew available). Using the values of each job impact factor and the multipliers of unit productivity, the unit productivity for the industry standard job can be estimated. Subsequently, the labor forecast for the job can be estimated based on unit productivity and the goal metric of the job.

Machine learning (ML) can be further used to discover trends and refine the machine learning model 52 and labor forecasting engine 22 based on estimates and actual completion cost for complex projects. The labor forecasting engine 22 uses data based on past historical jobs based on industry standard job classifications 38 and historical job records 40 using job impact factors 34 provided by the machine learning model 52 which are be used by the labor forecasting engine 22 to estimate the labor costs of future jobs. A historical job record 40 and its associated industry standard job classification 38 from the job classification database 14 can be used to provide a labor forecast for a specific new job. Comparisons are made between the various dynamic job conditions and the unit productivity to provide a correlation of various job impact factors to labor forecast. These correlations can range from 0 (no correlation) to 1 (linear correlation) and the job impact factors for the job can then be ranked in value from highest to lowest to determine the most relevant or key job impact factors, which can be applied to the labor forecasting engine 22. In machine learning, sometimes the data points available for a detailed sub-type of a job are not sufficient.

Correlation and job impact factors between job types and industry standard job classifications from the job classification database 14 may also be used to infer job impact factors based on similar job types. For example, porcelain tiling is similar to stone tiling, with a linear factor of complexity. In this way the present system can provide a labor forecast for a job that has never been done before using job impact factors from similar industry standard jobs and can use machine learning to examine existing past data to see how jobs are done. By layering in an adjustment factor to learn from data, with significantly fewer datapoints the present method and system for labor forecasting can figure out which job impact factors contribute most to job completion and are therefore most critical to preparing a labor estimate for a job.

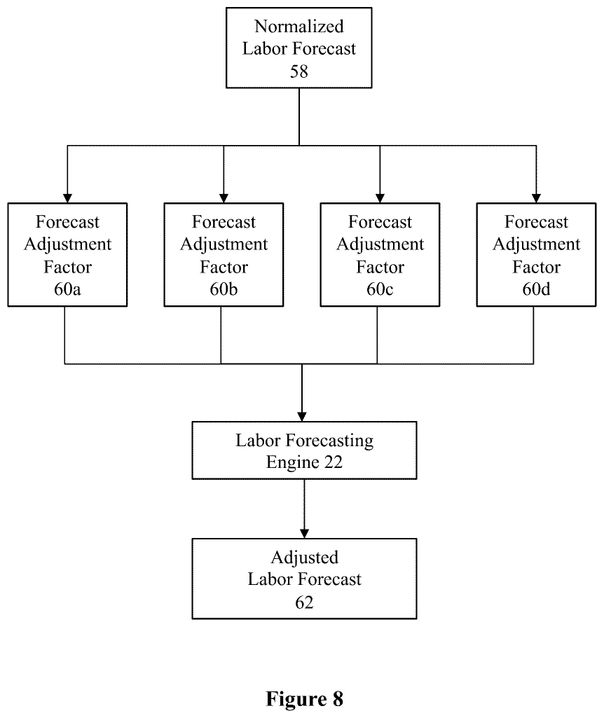

FIG. 8 is a flowchart illustrating a method for applying a plurality of forecast adjustment factors to a normalized labor forecast to provide an adjusted labor forecast for a new job. A normalized labor forecast 58 can be generated by a labor forecasting engine based on a historical dataset of historical jobs that are similar to the new job for which labor is being forecasted. The similar historical jobs in the historical job database selected for inclusion in the initial model can have the same job classification identifier as the new job being forecast, or, if a sufficient number of historical jobs are not available as required for the forecasting model, jobs that are in the same subcategory or category as the job classification identifier of the new job. Based on the job classification identifier of the new job being forecast, a set of key impact factors can be identified that affect the labor required. The identification of key impact factors for each industry standard job having a job classification identifier can be done, for example, in advance based on historical queries and be part of the historical job record, by a new query to a database containing information on factors affecting the industry standard job or those in its category, by querying workers or other people in the industry with familiarity with the job, or a combination thereof. Based on the correlation calculations, the most influential job impact factors are identified as key job impact factors, and forecast adjustment factors 60a, 60b, 60c, 60d for each key job impact factor is calculated based on the amount of effect that each of the key job impact factors has on the industry standard job. The forecast adjustment factors 60a, 60b, 60c, 60d can then be applied to the normalized labor forecast 58 in the labor forecasting engine 22 to provide a complexity adjusted labor forecast 62.

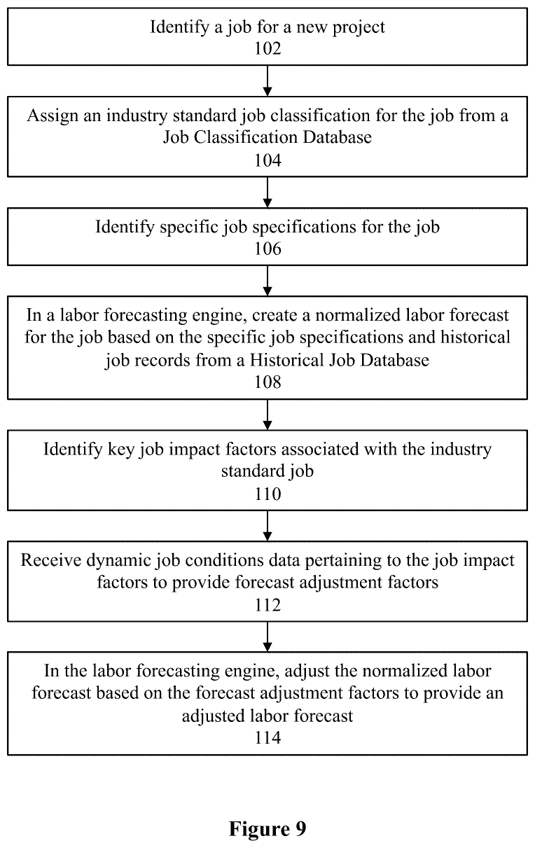

FIG. 9 is a flowchart illustrating a method for forecasting the labor requirement for a new project using the present system and method for industrial labor forecasting. For a new project the forecasting platform receives a plurality of jobs required for the project with specifications for each job. To forecast the labor for each job in the project job requirements and job specifications are identified for the new project 102. Classification identifiers are assigned for each job in the project which are associated with an industry standard job from the job classification database 104 as required by the new project. For each job in the project, historical job records are retrieved from the historical job database 106 that are relevant to each job according to the industry standard job classification. The job impact factors affecting completion of each job can be determined based on the relevant historical job records and job specifications for the new construction project and/or parts thereof. Based on the historical job records for the industry standard job classification and the job requirements and job specifications for the new construction job, a normalized labor forecast forecasting the labor required for each individual job can be done in a labor forecasting engine 108. Key job impact factors associated with the industry standard job can be identified 110, where the key job impact factors have a significant effect on the labor required to do the job. Dynamic job conditions data pertaining to the job impact factors are then applied to provide forecast adjustment factors 112. In the labor forecasting engine, the normalized labor forecast can then be adjusted based on the forecast adjustment factors to provide an adjusted labor forecast 114.

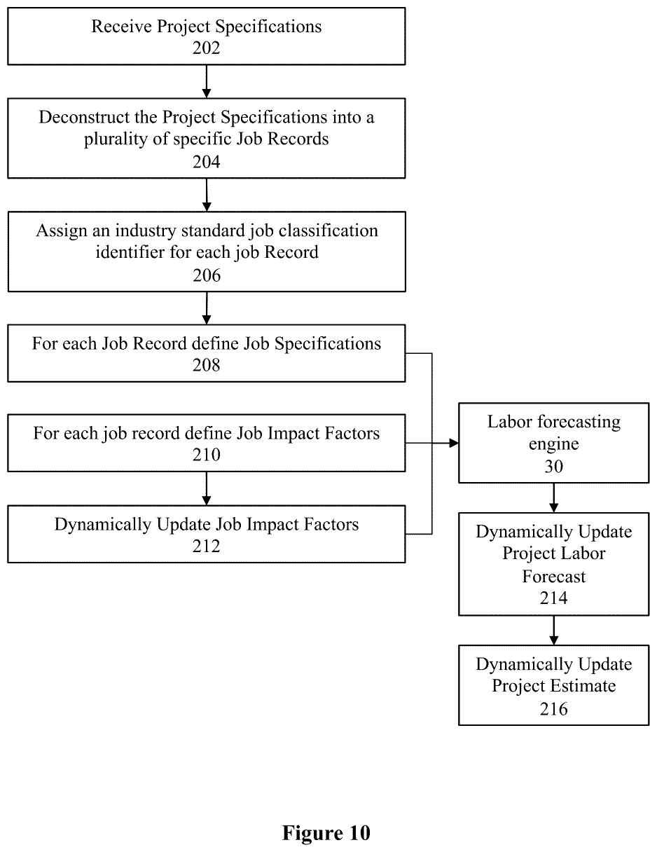

FIG. 10 is a flowchart illustrating a method for deconstructing a new project into a set of industry standard jobs and dynamically updating a project estimate. Job specifications for the new project are received 202 and the new project is deconstructed into a plurality of jobs with a plurality of job records required based on the project specifications 204. A classification identifier is then assigned for each job record 206 which corresponds to an industry standard job in a job classification database. For each job record the job specifications can be defined 208 and the job impact factors for each job record can be defined 210. Job impact factors can be also dynamically updated 212 during the job and project based on worker and other data input to update the labor forecast for the job and project. Labor forecasting engine 30 receives the job specification, job impact factors, and the dynamically updated job impact factors and uses these to apply forecast adjustment factors to calculate the labor required for the job specifications for a specific set of job requirements. The project and job labor forecast can by dynamically updated 214 such that the project estimate can also be dynamically updated 216 based on the changing project and job conditions. In this way the present system and method can provide a mechanism for the collection of valuable data for contractors and construction supervisors directly from workers that might not otherwise be obtainable. This dynamic labor forecast updating provides granularity on the prediction of how various environmental, geographical, weather, and other factors are affecting the labor required for a specific job and/or project and dynamically update the cost of the job or project. The collection of data can be obtained, for example, from a conversational model with workers and/or passively through analyzing notes and other structured or unstructured data to glean relevant information. The present system and method also allows smaller contractors the ability to tailor their labor cost forecasts to their exact circumstances and job requirements in a data-driven and automated manner.

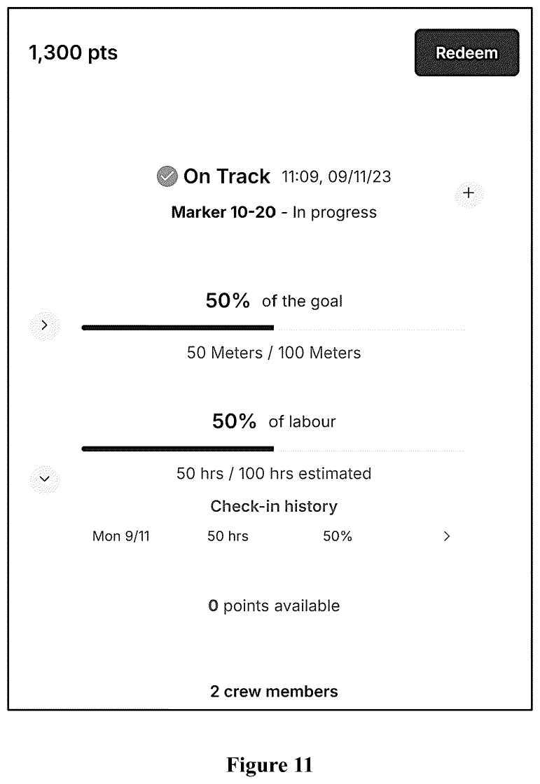

FIG. 11 illustrates a graphical user interface of an example work digest on a peripheral device for a job worker. The digest can be thought of as a human-friendly way of conveying critical information about the work and goal for helping the worker understand the requirements related to the task/goal. The digest may also include a training or guidance component depending on the worker skill and experience. The digest can provide a worker with their work assignment for the day, weather conditions, site conditions, progress summary towards their goal, notes from their site leaders or supervisor that they want them to be aware of, and/or educational materials. The digest can be provided on the worker's peripheral device, for example, in an app, as a text, email, or link. The digest, preferably, can be summarized in an easy to understand short (e.g. 3 minute) format, and the delivery of the digest can be done using, for example, natural language text, audio, or video, optionally generated by AI. In one example, a job digest for a worker can be a digest message that reads as follows:
Hey Bob! Good morning. Here's the quick rundown of the day: We aim for 47,500 tonnes this week, averaging 9,500 per day. We're at 10,244 so far, slightly behind where we should be due to the Monday unscheduled shutdown because of the breakdown. The weather is good for the rest of the week, allowing us to catch up if we focus and keep up with the maintenance. As always, focus on safety, housekeeping, and inspections. Everyone can earn 250 points for pitching in. Let me know if you have any other questions!

For another person who had a sick day on Monday, and whose preferred language is Spanish, an example digest message of the day is:
[symbol] Buenos días Randy! Espero que hoy the sientas mejor. Te extrañamos el lunes. Aquí está un resumen rápido de la semana hasta el momento: nuestro objetivo es 47.500 toneladas esta semana, un promedio de 9.500 por día. Hasta ahora estamos en 10.244, ligeramente por detrás de donde deberíamos estar debido al cierre no programado del lunes debido a la avería. El tiempo acompaña para el resto de la semana, lo que nos permitirá ponernos al día si nos concentramos y seguimos con el mantenimiento. Como siempre, céntrese en la seguridad, la limpieza y las inspecciones. Todos pueden ganar 250 puntos por colaborar. [symbol] Avísame si tienes alguna otra pregunta!

Providing updates to workers pertaining to the type of the work they are undertaking as a digest is a way of combining what everybody should know that is relevant to their work. The digest can also incorporate the external factors (e.g. weather, site conditions) as well as supervisory notes, work assignment specific notes such as pertaining to the use of particular materials, tools, and techniques, all of which could be tailored for the experience of the individual worker. The digest can also provide a work or job goal for a job work crew, set weekly goals for the crew, and update the crew instantly on their progress on their goals. Crews can be given clear job goals and a communication to a worker's peripheral device can communicate progress with the crew and provide regular progress updates to their crew through the app to track work progress. The digest can also identify the job impact factors relevant to the job that the crew is doing and further query the worker on details relating to these job impact factors. Incentives can also be provided to workers to report on details related to job impact factors and to be efficient about job work. When project targets are hit, the project or job stays on schedule, and the crew can be further incentivized by earning rewards for efficient work. This is a win-win situation for the crew and also for the company. Additionally, the present system empowers workers to apply their technical knowledge to be able to work smarter on a construction or industrial site to improve individual and team work for the benefit of the company.

The digest is preferably in the form of or includes a check-in update that provides an update on the progress towards the goal and/or notes from the site leader. This real time feedback loop can create an opportunity for workers to take initiative to keep the work on track, inform the workers of the influences on job productivity, and provide positive motivation. In use with 100 workers, it was observed that digest feedback having some specificity around the job conditions and job progress can measurably improve worker productivity. An example of weak feedback notes in the work digest that do not have job specificity include:
Day 1: Good job!
Day 2: Good job guys!
Day 3: Well done guys!

An example of strong feedback notes in the work digest that include specificity around the job progress and factors affecting job progress that was found to elicit motivation and initiative include:
Day 1: The crew started the week strong. Although there were high winds, we managed to install 10 panels.
Day 2: This was a record breaking day, installing 12 panels. We had the weather on our side. Keep an eye on the material delivery for tomorrow. Keep up the good work.
Day 3: Today was a tough day but we managed to hit our target at the very last minute. Great learning for next time. We need to leave ourselves more room for unpredictability. Amazing job everybody.

The system can help the site leader improve the quality of their notes included in the work digest or in their daily check-in by leveraging a Large Language Model (LLM) style Artificial Intelligence (AI) to provide generated text. The generated text can prompted with providing text to capture sentiments and tone that is motivating to workers. This generative recommendation and feedback can be further tested in the form of a quality score and compared to productivity change for reinforcement learning and weather the message is going to be motivating and provides specific feedback.

The system can further track crew and worker productivity by measuring progress and closing the gap between work envisaged or required and work performed objectively. Crews can then be provided, in a graphical user interface, a performance summary and a clear view of their pace to achieve the schedule. Weekly and/or daily goals can be set by the company or crew leader/foreman. By providing real incentives for smart work, the crew is motivated to get work done on time by receiving a reward when work is completed on or before schedule. By providing real time progress feedback to the crew, the crew has a chance to take initiative to keep the project on track. When the crew completes the goal on time, the team shares the reward equally. If they finish faster, they can potentially get more reward. Crew/site leaders can further set a short term goal for the crew to stay on schedule which can be shared with their crew so everyone knows exactly what needs to be done and by when. Crew members can be encouraged to problem solve within their team to improve crew functioning and improve team productivity and are encouraged to take initiative to improve the quality and/or efficiency of their work. Based on use of the present system in the field, it has been found that solutions to improving productivity are not simply to work harder, but mostly come from working smarter. The present method and system enables skilled workers to use their knowledge and creativity to solve problems so that they are more productive, empowering the experience and knowledge of workers who know how do the work to solve problems and work smarter. Crews can thereby use their time more wisely and can apply their own creativity on the job to make the job easier, go faster, and provide a better work product. Crew team camaraderie helps crew teams do a better job together and celebrate their achievements with friendly competition. Incentives for workers to perform at or better than their targets can include, for example, offers rewards such as gift cards, social events, food for the crew, financial perks, and time off. The reward given to workers can be significant to workers but worth so much more to the company to get work done expediently and also get the benefit of happy workers. The rewards offered to workers can also be far less than what can be gained from more productive work, meaning improvements in productivity results in a win-win for the company as well as the workers. Work tracking synchronization with information transfer in a medium that appeals to workers opens up access to technology to a larger audience of workers whose main technology touchpoint is a peripheral mobile device such as a smartphone. The present system is already in use in the market and is being used by industrial companies and their workers. In use, every pilot of the present platform has seen at least a 10% productivity increase on the industrial site.

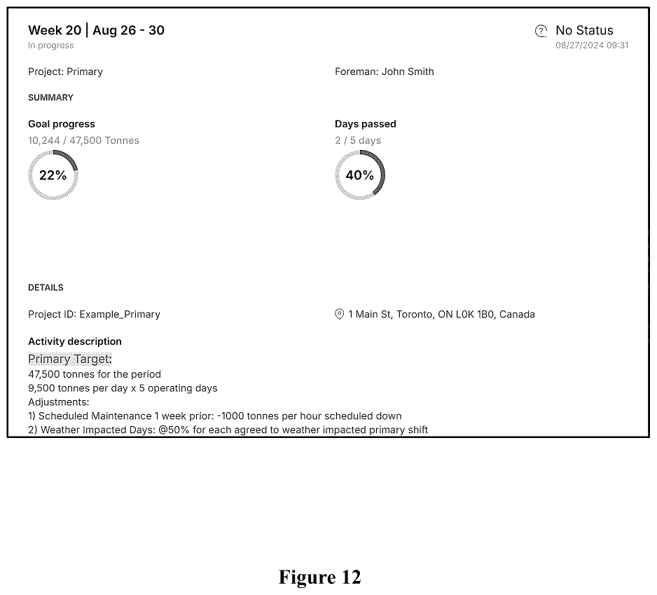

FIG. 12 illustrates a graphical user interface for a job record for an earthworks industrial job for a job manager. The graphical user interface providing feedback on the status of a job as shown indicates the activity description, goal progress, and target completion date. Adjustments are also indicated which provide additional information on the job progress and any job impact factors that may have contributed to the job progress.

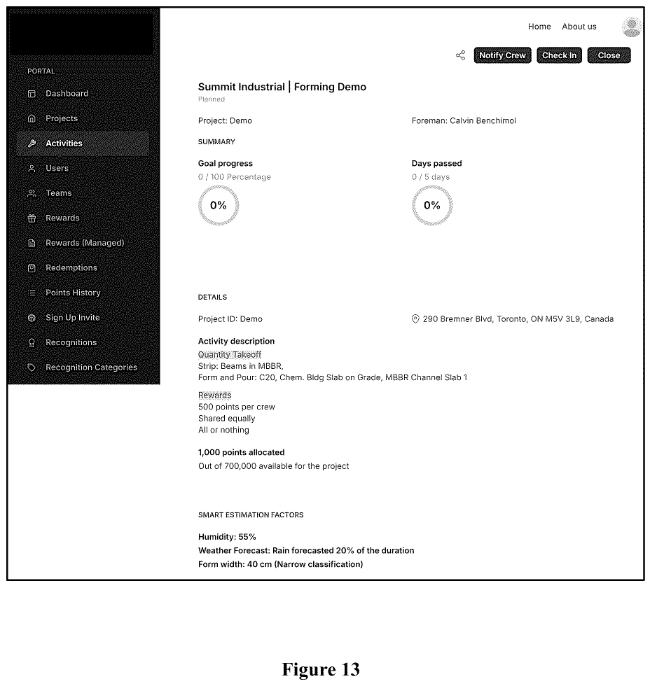

FIG. 13 illustrates a graphical user interface of a specific job record for a concrete forming industrial job identifying key job impact factors and job requirements. The job record has a reporting on the activity description, job impact factors (humidity, weather, form width), and incentives provided to the crew providing an incentive for efficiently getting the job done.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method for labor forecasting comprising:
creating a new job record for a new job, the new job record comprising job specifications and having a classification identifier associated with an industry standard job record;
identifying a plurality of historical job records in a historical job database having the same classification identifier as the new job record, each historical job record describing a historical job comprising historical job specifications specific to the historical job;
in a labor forecasting engine, receiving the plurality of historical job records pertaining to the job classification identifier and creating a normalized labor forecast based on the plurality of historical job records;
identifying one or more job impact factors associated with the industry standard job; and
adjusting the normalized labor forecast for the new job record based on the job impact factors to provide an adjusted labor forecast.

2. The method of claim 1, wherein the industry standard job record comprises job requirements for the industry standard job.

3. The method of claim 1, wherein the classification identifier of the new job record is in a category or subcategory of each of the plurality of historical job records used to create the normalized labor forecast.

4. The method of claim 1, wherein the job is an industrial project, construction project, or industrial manufacturing.

5. The method of claim 1, further comprising querying a worker on details pertaining to the job impact factors.

6. The method of claim 5, further comprising incorporating the details pertaining to the job impact factors into the adjusted labor forecast.

7. The method of claim 1, further comprising creating a work digest relevant to the new job and communicating the work digest to a worker.

8. The method of claim 7, wherein the work digest comprises one or more of text, an image, audio, and video.

9. The method of claim 7, wherein the work digest provides information on one or more of job conditions, job requirements, job specifications, and job best practices for the new job.

10. The method of claim 7, wherein the work digest comprises generated text provided by a Large Language Model, and wherein the generated text reflects sentiments and tone to motivate the worker.

11. The method of claim 7, wherein the work digest comprises specific information about the new job and its progress.

12. The method of claim 1, wherein the job impact factors comprise one or more of weather, time of year, job location, soil or ground type where the job is located, humidity, temperature, surface water level, labor market, materials used, and equipment used.

13. The method of claim 1, further comprising, once the job is completed, adding the new job record as a new historical job record to the historical job database.

14. The method of claim 1, further comprising providing a worker with a goal for completing the job within a time allotment for the labor forecast, and rewarding the worker for completion of the job within the time allotment.

15. A system for labor forecasting comprising:
at least one processor coupled to one or more memory, the one or more memory comprising:
a job classification database comprising a plurality of industry standard job records, each industry standard job record comprising a job description for an industry standard job and a job classification identifier;
a historical job database comprising a plurality of historical job records, each historical job record describing a historical job associated one of the plurality of industry standard job record in the job classification database;
a job generation engine for creating a new job record, the new job record comprising new job specifications and associated with one of the plurality of industry standard job records by the job classification identifier; and
a labor forecasting engine for receiving the plurality of historical job records pertaining to the job classification identifier, creating a normalized labor forecast for the new job, and identifying one or more job impact factors associated with the job classification identifier, wherein the labor forecasting engine adjusts the normalized labor forecast for the new job based on the identified job impact factors to provide an adjusted labor forecast for the new job.

16. The system of claim 15, further comprising a peripheral device for querying a worker about the identified job impact factors and receiving details on the one or more job factors.

17. The system of claim 15, wherein the job impact factors comprise one or more of weather, time of year, job location, soil or ground type where the job is located, humidity, temperature, surface water level, labor market, materials used, and equipment used.

18. The system of claim 15, wherein the industry standard job record comprises job requirements for the industry standard job.

19. The system of claim 15, wherein the job classification identifier is in a category or subcategory of each of the plurality of historical job records used to create the normalized labor forecast.

20. The system of claim 15, wherein the industry standard job is an industrial project, construction project, or industrial manufacturing.
